(19) United States
(12) Patent Application Publication
(10) Pub. No.: US 2013/0311224 A1
(43) Pub. Date: Nov. 21, 2013

(54) System and Method for Automated Standards Compliance

(71) Applicants: Richard W. Heroux, Port St. Lucie, FL (US); Paul E. Nowling, Sparks, NV (US); Warren R. Federgreen, Jensen Beach, FL (US); Julie E. Hurley, Mountain View, CA (US); Linda Grimm, Hydesville, CA (US); Mark Brady, Dix Hills, NY (US)

(72) Inventors: Richard W. Heroux, Port St. Lucie, FL (US); Paul E. Nowling, Sparks, NV (US); Warren R. Federgreen, Jensen Beach, FL (US); Julie E. Hurley, Mountain View, CA (US); Linda Grimm, Hydesville, CA (US); Mark Brady, Dix Hills, NY (US)

(21) Appl. No.: 13/863,863

(22) Filed: Apr. 16, 2013

Related U.S. Application Data
(60) Provisional application No. 61/624,472, filed on Apr. 16, 2012.

(51) Int. Cl. G06Q 30/00; G06Q 10/06

(52) U.S. Cl. CPC G06Q 30/018; G06Q 10/06311
USPC 705/7.15

(57) ABSTRACT

A method and system for risk assessment. A question set including one or more questions may be transmitted. Each question may be based on statutory, sectoral or standards requirements relating to how an entity handles information, and each question may be associated with one or more categories. An answer set may be received including one or more selected answers. Each selected answer may correspond to a question in the transmitted question set and each selected answer may be associated with a risk score. The risk score may be related to the statutory, sectoral or standards requirements. An assessment based on the answer set may be generated and transmitted. The assessment may include one or more questions and corresponding answers organized by risk score and category. A request for remediation action may be generated and transmitted when an answer corresponding to a question is associated with a risk score above a threshold risk score.

### PRIORITY AND RELATED PATENTS

This application claims priority to U.S. Provisional Patent Application Ser. No. 61/624,472, entitled System and Method for Automated Standards Compliance, filed on Apr. 16, 2012. This application is related to U.S. patent application Ser. No. 13/336,334 entitled “Method and System for Standards Guidance” filed on Dec. 23, 2011, issued as U.S. Pat. No. 8,296,244, which is a divisional application claiming priority to U.S. patent application Ser. No. 12/196,919 entitled “Method and System for Standards Guidance” filed Aug. 22, 2008. All of the above-listed patent applications are incorporated herein by reference in their entirety.

### BACKGROUND

Many organizations obtain, store, and/or safeguard private information and/or data (e.g., health care related information or any other type of data) relating to individuals. Many different standards, rules, laws, regulations, and guidelines may apply to storage of private information. Complying with all of the standards, rules, laws, regulations, and guidelines may, therefore, be cumbersome.

### SUMMARY

Briefly, aspects of the present disclosure are directed to methods and systems for risk assessment. A question set including one or more questions may be transmitted. Each question may be based on statutory, sectoral or standards requirements relating to how an entity handles information, and each question may be associated with one or more categories. An answer set may be received including one or more selected answers, each selected answer corresponding to a question in the transmitted question set and each selected answer associated with a risk score, where the risk score is related to the statutory, sectoral or standards requirements. An assessment based on the answer set may be transmitted. The assessment may include the one or more questions and corresponding answers organized by risk score and category. A request for remediation action may be generated and transmitted when an answer corresponding to a question is associated with a risk score above a threshold risk score.

This SUMMARY is provided to briefly identify some aspects of the present disclosure that are further described below in the DESCRIPTION. This SUMMARY is not intended to identify key or essential features of the present disclosure nor is it intended to limit the scope of any claims.

The term “aspects” is to be read as “at least one aspect”. The aspects described above and other aspects of the present disclosure described herein are illustrated by way of example(s) and not limited in the accompanying figures.

### BRIEF DESCRIPTION OF THE DRAWINGS

A more complete understanding of the present disclosure may be realized by reference to the accompanying figures in which:

FIG. 1 is a flow diagram, which defines steps of a method according to aspects of the present disclosure.

FIG. 2 is a flow diagram, which defines steps of a method according to aspects of the present disclosure.

FIG. 3 is a flow diagram, which defines steps of a method according to aspects of the present disclosure.

FIG. 4 is a flow diagram, which defines steps of a method according to aspects of the present disclosure.

FIG. 5 is a flow diagram, which defines steps of a method according to aspects of the present disclosure.

FIG. 6 is a flow diagram, which defines steps of a method according to aspects of the present disclosure.

FIG. 7 is a view of a transmit and receive user interface according to aspects of the present disclosure.

FIG. 8 is a view of a transmit and receive user interface according to aspects of the present disclosure.

FIG. 9 is a view of a transmit and receive user interface according to aspects of the present disclosure.

FIG. 10 is a flow diagram, which defines steps of a method according to aspects of the present disclosure.

FIG. 11 is a flow diagram, which defines steps of a method according to aspects of the present disclosure.

FIG. 12 is a view of a transmit and receive user interface according to aspects of the present disclosure.

FIG. 13 is a view of a transmit and receive user interface according to aspects of the present disclosure.

FIG. 14 is a flow diagram, which defines steps of a method according to aspects of the present disclosure.

FIG. 15 is a flow diagram, which defines steps of a method according to aspects of the present disclosure.

FIG. 16 is a flow diagram, which defines steps of a method according to aspects of the present disclosure.

FIG. 17 is a schematic diagram depicting a representative computer system for implementing and exemplary methods and systems for risk assessment according to aspects of the present disclosure.

The illustrative aspects are described more fully by the Figures and detailed description. The present disclosure may, however, be embodied in various forms and is not limited to specific aspects described in the Figures and detailed description.

### DESCRIPTION

The following merely illustrates the principles of the disclosure. It will thus be appreciated that those skilled in the art will be able to devise various arrangements which, although not explicitly described or shown herein, embody the principles of the disclosure and are included within its spirit and scope.

Furthermore, all examples and conditional language recited herein are principally intended expressly to be only for pedagogical purposes to aid the reader in understanding the principles of the disclosure and the concepts contributed by the inventor(s) to furthering the art, and are to be construed as being without limitation to such specifically recited examples and conditions.

Moreover, all statements herein reciting principles and aspects of the disclosure, as well as specific examples thereof, are intended to encompass both structural and functional equivalents thereof. Additionally, it is intended that such equivalents include both currently known equivalents as well as equivalents developed in the future, e.g., any elements developed that perform the same function, regardless of structure.

Thus, for example, it will be appreciated by those skilled in the art that any block diagrams herein represent conceptual views of illustrative circuitry embodying the principles of the disclosure. Similarly, it will be appreciated that any flow charts, flow diagrams, state transition diagrams, pseudocode, and the like represent various processes which may be substantially represented in computer readable medium and so executed by a computer or processor, whether or not such computer or processor is explicitly shown.

The functions of the various elements shown in the Figures, including any functional blocks labeled as “processors”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random access memory (RAM), and non-volatile storage. Other hardware, conventional and/or custom, may also be included.

Software modules, or simply modules which are implied to be software, may be represented herein as any combination of flowchart elements or other elements indicating performance of process steps and/or textual description. Such modules may be executed by hardware that is expressly or implicitly shown.

Unless otherwise explicitly specified herein, the drawings are not drawn to scale.

Methods and systems may allow a user to assess risk associated with statutory, sectoral or standards requirements.

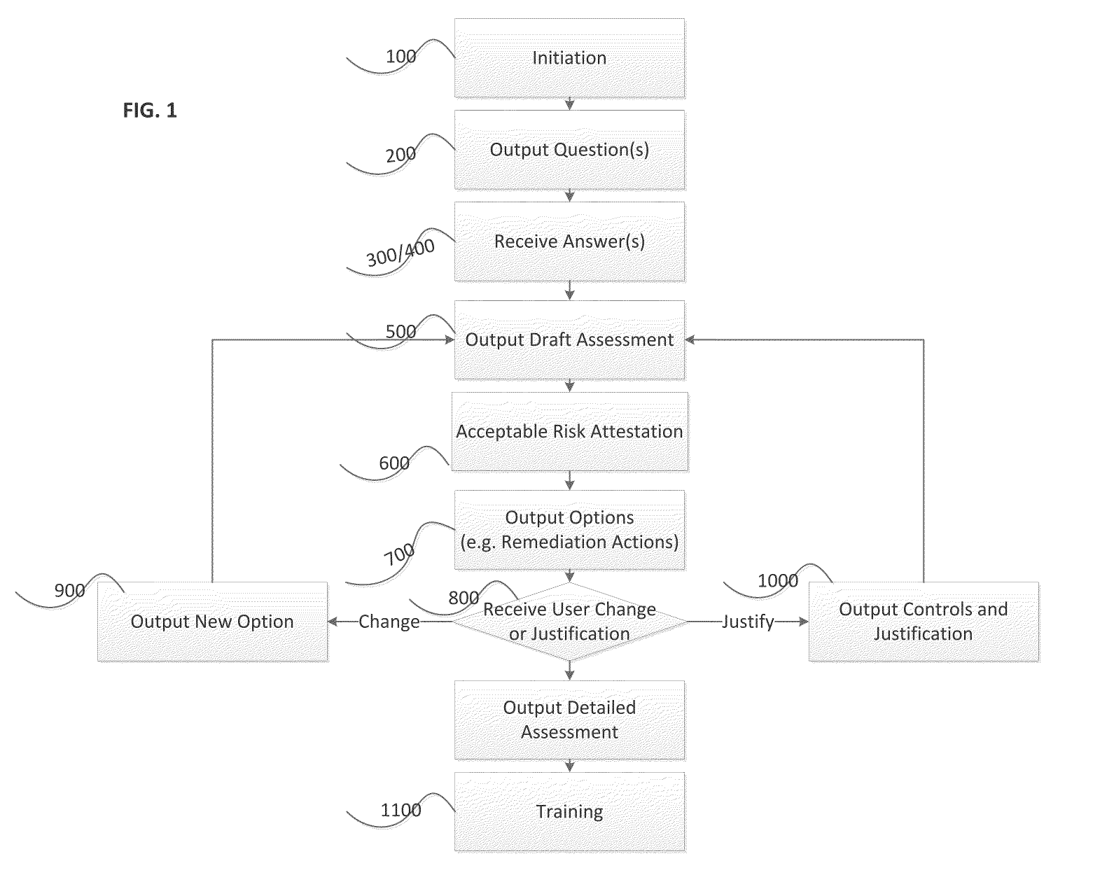

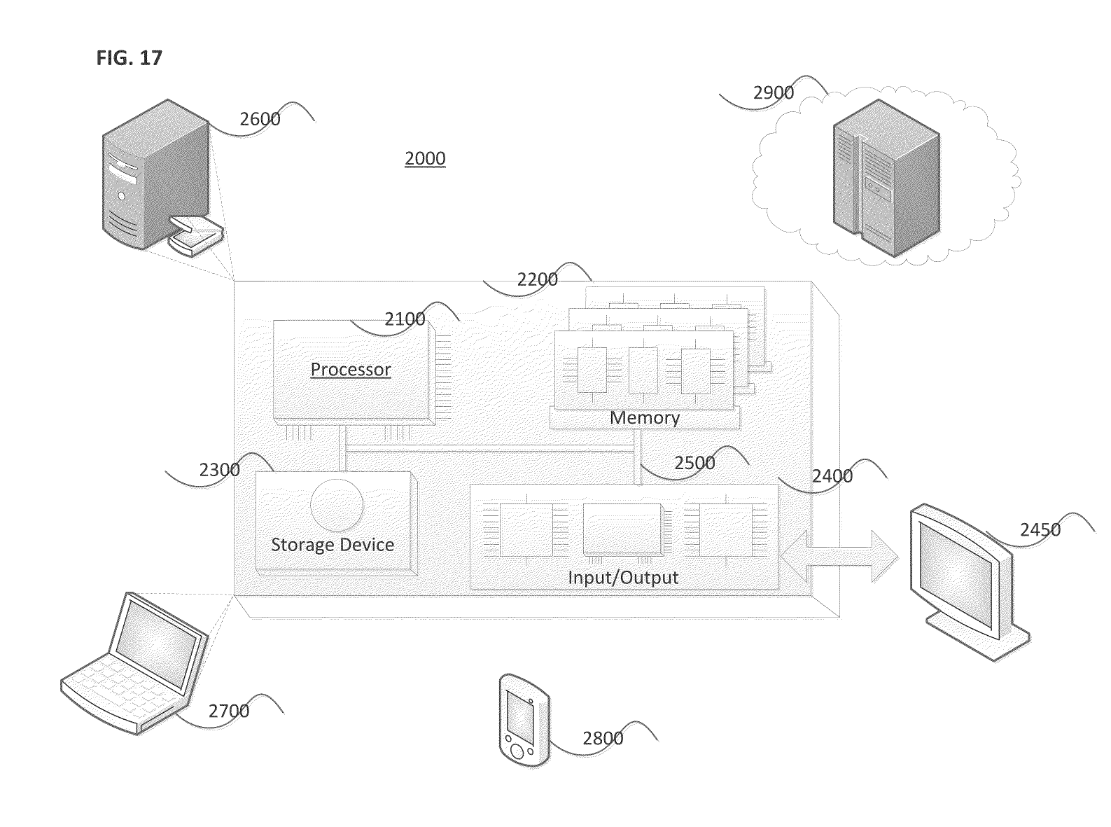

In FIG. 1, there is shown a flow diagram, which defines steps of a method according to aspects of the present disclosure. Methods and systems of the present disclosure may be implemented using, for example, a computer system 2000 as depicted in FIG. 17 or any other system and/or device.

In operation 100, an organization may be initiated and/or boarded into, for example, system 2000. A user (e.g., a user associated with an organization) may initiate and/or board an organization into, for example, system 2000 by creating a profile for the organization. A profile may be created by entering information related to the organization. Information related to an organization may include, for example, name, contact information, phone number, security question(s), and/or any other suitable information.

In operation 200, a question set including one or more questions may be output and/or transmitted. A question set may be transmitted from, for example, system 2000 (e.g., a server or other system) to a user. Each question may be based, for example, on statutory, sectoral or standards requirements relating to how an entity or organization handles information. Each question may be associated with at least one category. Questions in a question set may be, for example, simplified or expanded versions and/or translations of technical questions from at least one statutory, sectoral or standards source.

Questions in a question set (e.g., a questionnaire) may be output and/or transmitted in the form of multiple choice, freeform answer, short answer, or any other type of question. In an example in which questions are output as multiple choice questions, multiple possible answers (e.g., answer choices, answer options) may be output. Each possible answer may include, for example, text representing an answer, and the text representing the answer may be related to or representative of at least a portion of a statutory requirement. Each answer may be associated with a risk level (e.g., low, medium, high, or another value). In some aspects, multiple answers and/or responses may be selected, mutually exclusive answers may be selected, and other combinations of answers may be selected.

Questions in a question set may, for example, be related to, representative of, and/or linked to statutory, sectoral or standards requirements. Statutory, sectoral or standards requirements may be stored in, for example, a statutory, sectoral or standards requirements file and/or data structure. A question may, for example, be directly linked to specific provisions, sections, and/or portions of a statutory, sectoral or standards requirements file (e.g., a file associated with a statute, law, standard, and/or rule).

Questions in a question set may be associated with a weight, a maximum priority (e.g., a max priority), and/or other parameters. A weight may, for example, represent a criticality and/or importance of a question. A weight may, for example, be based on the criticality and/or importance of the statutory portion to which the question is linked. A weight may, for example, be a numeric value, a scalar, an integer, a percentage, and/or any other type of parameter. Maximum priority values are discussed in further detail below.

As shown in the following table and/or array, a question (e.g., “How are your records secured?”) may be associated with a category (e.g., physical safeguards), a weight (e.g., 0.5), a maximum priority value (e.g., yes), one or more possible answers, and/or possibly other information. Each of the one or more possible answers may be associated with a risk score (e.g., Low Risk, Medium Risk, and/or High Risk). In some aspects, all of the possible answers corresponding to a question may be associated with a category, weight, maximum priority, and other parameters associated with the question.

TABLE 1
Example Question and Corresponding Answer Set

| | | | Maximum | | Risk |
|---|---|---|---|---|---|
| Question | Category | Weight | Priority | Answers | Score |
| How are | Physical | 0.5 | Yes | Common area in | Medium |
| your | Safe- | | | locked file | Risk |
| records | guards | | | cabinet. | |
| secured? | | | | In a room secured | Medium |
| | | | | with a lock and | Risk |
| | | | | key. | |
| | | | | In room secured | Low |
| | | | | with keycard | Risk |
| | | | | Not Secured | High |
| | | | | | Risk |

Statutory, sectoral or standards requirements as discussed herein may be, for example, Sarbanes-Oxley Act of 2002, Gramm-Leach-Bliley Act (GLBA), Fair Credit Reporting Act (FCRA), Children's Online Privacy Protection Act of 1998 (COPPA), Driver's Privacy Protection Act of 1994, United States Telemarketing Sales Rule (TSR), Uniting and Strengthening America by Providing Appropriate Tools Required to Intercept and Obstruct Terrorism Act of 2001 (USA PATRIOT), Controlling the Assault of Non-Solicited Pornography and Marketing Act (CAN SPAM), Telephone Consumer Protection Act of 1991 (TCPA), Junk Fax Prevention Act of 2005 (JFPA), National Do Not Call Registry, Communications Assistance for Law Enforcement Act (CALEA), International Money Laundering Abatement and Anti-Terrorist Financing Act of 2001, Privacy Act of 1974, Freedom Information Act (FOIA), Health Insurance Portability and Accountability Act of 1996 (HIPAA), Health Information Technology for Economic and Clinical Health (HITECH) Act, state laws and/or regulations, and/or any other statutory, sectoral or standards requirements.

In some aspects, the statutory requirements may be, for example, health care statutory requirements. The statutory requirements may be related to, for example, the methodologies, procedures, safeguards, and/or protocols that a health care entity uses in handling health care related information and other private information. A health care entity may be, for example, a health care provider, health care payer, health care clearinghouse, a health plan, service provider, business associate, and/or any other entity related to health care. Health care related information may include, for example, patient health records, test results, physician notes, and many other types of information. By way of example, questions in a question set may be related to, for example, a health entity's compliance with HIPAA, HITECH, or other requirements. Questions in a question set may be related to, for example, privacy, security, and/or other HIPAA, HITECH, or other regulations.

Questions may be, for example, associated with one or more categories. Categories may, for example, be related to statutory, sectoral or standards requirements (e.g., requirements included in HIPAA, HITECH, and/or other rules, regulations, or statutes). Categories may include, for example, physical safeguards; technical safeguards; organizational requirements; administrative safeguards; policies, procedures and documentation requirements; and/or any other possible category. One or more questions may be output, for example, to user as a set of questions (e.g., questionnaire), and answers to the one or more questions may be included in a set of answers (e.g., an answer set).

In operation 300/400, an answer set including one or more selected answers (e.g., responses) may be received. An answer set may be received at, for example, system 2000 (e.g. a server or other device). Selected answers (e.g., in an answer set and/or set of answers) may be received, for example, from a user in response to transmitted questions. Each selected answer may correspond to a question in the outputted question set and each selected answer may be associated with and/or assigned a risk score. Each question (e.g., in the question set) may, for example, include one or more possible answers, and each of the possible answers may be associated with a risk score. A risk score may, in some aspects, be a text value, a real number, an integer, a scalar, or any other type of score and/or parameter. A risk score may, for example, be low risk, medium risk, high risk, or any other risk score.

In an example in which multiple choice questions are output, each question may be associated with a maximum priority. Each possible answer to a question may be associated with a predetermined risk score and/or a maximum priority. A predetermined risk score may be representative of, for example, a level of deviation from and/or risk of non-compliance with a statutory requirement (e.g., HIPAA, HITECH, or other requirements). A maximum priority value may be associated with a question and one or more answers associated with that question. A maximum priority may, for example, be a yes or no value, binary value (e.g., one or zero), or any other parameter. A maximum priority value of yes may indicate, for example, that an overall risk score for an answer set (e.g., one or more answers in an answer set) may not drop below the risk value of that answer.

In some aspects, an overall risk may be calculated for an answer set based on the risk scores, weights, and maximum priority associated with each question and corresponding selected answer. If, for example, a question is assigned a maximum priority value of yes, the risk score associated with the answer selected for that question may be the highest possible overall risk score for the answer set.

In operation 500, a draft assessment based on the answer set may be generated and transmitted. A draft assessment based on the answer set may be generated by, for example, system 2000 (e.g., a server or other device) and transmitted from system 2000 to a user. A draft assessment (e.g., a report) may include, for example, one or more questions and corresponding answers organized by risk score and category. A draft assessment may be transmitted to, for example, a user. A draft assessment may include a section for each risk score (e.g., high risk, medium risk, low risk, or other risk score(s)). Each risk score section may include at least one category (e.g., physical safeguards, technical safeguards, organizational requirements, administrative safeguards, policies and procedures and documentation requirements, and/or other categories). Each category may include one or more questions and corresponding answers. For example, an assessment may include a high risk section, medium risk section, a low risk section, and possibly other sections. A high risk section may include each of the selected answers and corresponding questions categorized as high risk. The answers and corresponding questions classified as high risk may be organized by category associated with each of the questions and corresponding answers. The high risk section may include, for example, three categories (e.g., physical safeguards, technical safeguards, and organizational requirements). Each category may include each question and corresponding answer associated with a risk score of high risk in that category. By way of example, the physical safeguards section of the high risk section may include, for example, a question “How are your records secured?” and corresponding answer “Not secured” that may be identified as high risk.

In some aspects, if an answer set does not include answers associated with a risk score, an assessment for that answer set may not include a section for that risk score. Similarly, if an answer set does not include answers associated with a risk score within a category, that category will not be displayed in the section of the assessment for that risk score. If, for example, an answer set does not include any answers assigned a risk score of high, an assessment may not include a high risk section. The assessment may only include, for example, low risk, medium risk, and possibly other sections. Similarly, if an answer set does not include any answers assigned a risk score of high and associated with a category of technical safeguards, a high risk section of an assessment may not include a technical safeguards category.

If the user finds the overall risk set forth in the draft assessment substantially in compliance, the user can attest to the risk in operation 600. In operation 700, it may be determined based on one or more risk scores associated with one or more selected answers, and/or based on the user's response in operation 600, whether to transmit additional options. In one example, each of one or more selected answers in a set of answers may be below a predefined threshold, and it may be determined that the selected answers in answer set are in compliance, substantially in compliance, and/or in accord with statutory, sectoral or standards requirements (e.g., health care related statutory, sectoral or standards requirements) relating to how an entity handles information (e.g., health care related information).

In operation 700, if at least one selected answer is associated with a risk score above a threshold risk score, a request for remediation action (e.g., task, user option) may be generated and/or transmitted. A request for remediation action may be generated by, for example, system 2000 (e.g., a server or other system) and transmitted from system 2000 to a user. If, for example, a selected answer is associated with a risk score of medium, high, or another value, a request for remediation action for that answer may be transmitted. A remediation action may be, for example, an action taken to correct, alter, modify, and/or otherwise change a condition related to an answer. A request for remediation action may include, for example, a representation of a selected answer, the question associated with the selected answer, information representing suggested remediation actions, a list of information representing remediation actions (e.g., a list of remediation actions), a representation of one or more statutory, sectoral or standards requirements related to the answer (e.g., a link to the statutory, sectoral or standards requirements and/or a representation of the statutory requirement), and/or possibly other information.

In operation 800, a response to a request for remediation action may be received. In some aspects, in response to a request for remediation action, a user may, for example, select a remediation action (e.g., a task) from a list of remediation actions. In some aspects, a user may select a response indicating no action be taken (e.g., to leave an answer and/or response as is or selecting ‘leave as is’) in response to the request for remediation action.

In operation 900, a response associated with a lower risk score may be received, and a prompt to justification information may be transmitted. Justification information may be, for example, an estimated date of completion (e.g., due date of completion), a cost associated with the remediation action, and possibly other information. The received response (e.g., a response associated with a lower risk score), a question associated with the received response, a request to enter an estimated date of completion, a request to enter an estimated cost of completion, and/or possibly other information may be transmitted.

In some aspects, an estimated date of completion, an estimated cost of completion, and/or other information may be received. Based on the received information, an updated assessment (e.g., an updated detailed assessment) may be generated and transmitted. An updated assessment may include, for example, one or more questions and corresponding selected answers organized by risk score and category, information representing a remediation action assigned, and possibly other information. Information representing a task and/or remediation action assigned may include a received response (e.g., a response to the request for remediation action) associated with a lower risk score, a received estimated date of completion, a received estimated cost of completion, and possibly other information.

In some aspects, an option to alter a remediation action may be transmitted. An option to alter a remediation action may be, for example, a button or link allowing a user to select a revised response to the request for remediation action. A user may alter the remediation action by selecting alternate or different remediation action (e.g., a remediation action associated with a different risk score). A user may alter a remediation action by selecting to leave the answer as is and/or by taking no action.

According to some aspects, information indicating completion of a remediation action may be received. For example, a user may input information indicating that remediation action has been completed. Once a remediation action has been completed, an assessment may be transmitted to, for example, a user. The assessment may include one or more questions and/or remediation actions organized by risk score and category. For example, a low risk section may include a physical safeguards category. The physical safeguards category may include, for example, one or more questions (e.g., “how are your records secured?”), a received response (e.g., a completed remediation task, for example, “records are secured in a room with biometric controls such as a fingerprint reader) for that question, and risk score after completion of the remediation task (e.g., low risk).

In some aspects, a list of tasks and/or remediation actions may be transmitted. A list of tasks and/or remediation actions may be transmitted in response to, for example, a request received from a user to generate a task list (e.g., by selecting an “output a task” list tab). A list of remediation actions may include, for example, uncompleted remediation actions section, a completed and/or closed remediation action section, and/or possibly other sections. An uncompleted remediation actions section may include, for example, a list of uncompleted remediation actions, due dates associated with the remediation actions, estimated cost associated with each remediation action, a prompt (e.g., a button and/or link) allowing a user to change due dates associated with each remediation action, a prompt (e.g., a button and/or link) allowing a user to change estimated cost associated with each remediation action, a prompt allowing a user to designate a remediation action completed, and possibly other information. A completed and/or closed remediation actions section may include, for example, a list of completed remediation actions, a date of completion for each remediation action, a cost of completion for each remediation action, and possibly other information. In some aspects, remediation actions may be sorted by status (e.g., open, completed, all, or other status), due date, cost, and/or any other parameter.

In operation 1000, if a remediation action (e.g., a response) associated with a lower risk score is not selected, a prompt to enter current controls in place to mitigate risk, an assessment of how the current controls satisfy statutory, sectoral or standards requirements, and a user determined risk score may be transmitted. A remediation action associated with a lower risk score may not be selected if, for example, no response is received or a response is received to leave an answer unchanged, as is, and/or unmodified. A prompt to enter current controls in place to mitigate risk may be, for example, an input field allowing a user to input text, information, and/or data. A prompt to enter current controls may include, for example, a prompt stating “HIPAA regulations require that you describe controls in place to mitigate this risk:” or any other prompt in proximity to a text entry field. A prompt to enter an assessment of how the current controls satisfy statutory requirements may be, for example, an input field allowing a user to input text, information, and/or data. A prompt to enter an assessment may include, for example, a prompt requesting a user to “describe your assessment of how these controls meet HIPAA requirements:” or any other prompt in proximity to a text entry field. A prompt to enter a user determined risk score may, for example, be a prompt to select a risk score from a list of scores, a text entry field, and/or any other type of prompt.

In some aspects, current controls in place to mitigate risk, an assessment of how the current controls satisfy statutory, sectoral or standards requirements and a user determined risk score may be received. Based on the received current controls, assessment, and user determined risk score, an updated assessment (e.g., an updated detailed assessment) may be generated and transmitted. An updated assessment may include, for example, one or more questions and corresponding answers organized by risk score and category. For each question and corresponding answer that was not altered based on a request for remediation action, information representing current controls in place to mitigate risk, information representing an assessment of how the current controls satisfy statutory, sectoral or standards requirements, a user determined risk score, and possibly other information may be received and processed.

After the user inputs a change, resulting in operation 900, or a justification, resulting in operation 1000, the user is then given a new draft assessment at operation 500, at which point the entire process iterates again. The process iterates for as many times as is necessary until the user no longer wishes to enter any changes or justifications, and attests to the assessed risk at operation 600, the user is presented with a detailed assessment and given the opportunity for training in operation 1100.

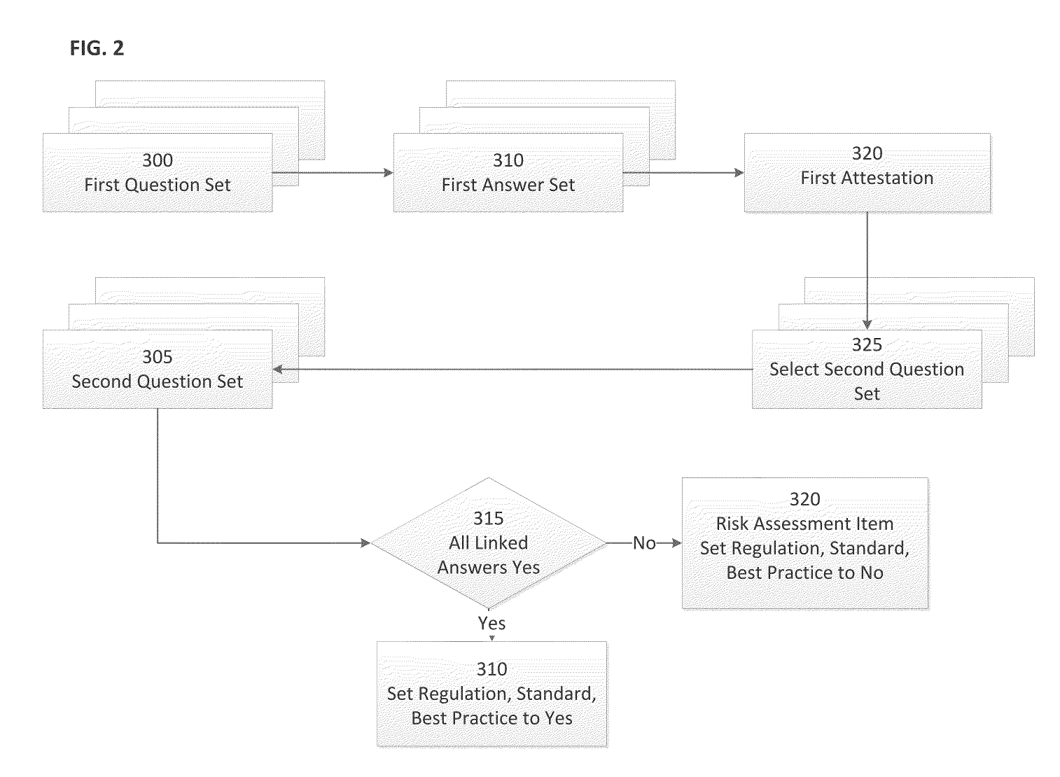

In FIG. 2, there is shown a flow diagram, which defines steps of a method according to aspects of the present disclosure. The flow diagram of FIG. 2 depicts greater detail relating to the process of asking and answering questions related to the compliance with a regulation, standard, or best practice, as depicted in operation 300/400 of FIG. 1. A set of questions 300 is shown. These questions can be stored in a memory in a system such as system 2000. One or more questions are stored relating to a single regulation, standard or best practice whose compliance is being tested by the system. The set of questions 300 have associated sets of answers 310, whereby, for example, an answer of “yes” to each question would indicate compliance with the regulation, standard or best practice. The user then attests to the answers in operation 320. After the first attestation, the system selects a second set of questions in operation 325, for example relating to the organization's handling of confidential information. The user is asked these questions in operation 305. In operation 315, the system tests for whether all answers 310 to the questions 300, and the answers to questions 305, that are given by the user are those answers required by the regulation, standard, or best practice. If so, the system sets an attribute for compliance with the regulation, standard or best practice to “yes” in operation 310. If any of the answers indicate non-compliance, the system sets an attribute for compliance with the regulation, standard or best practice to “no” in operation 320. It will be understood by persons having skill in the art that any one of the questions 300, or any set of questions, may relate to one or more regulation, standard, or best practice.

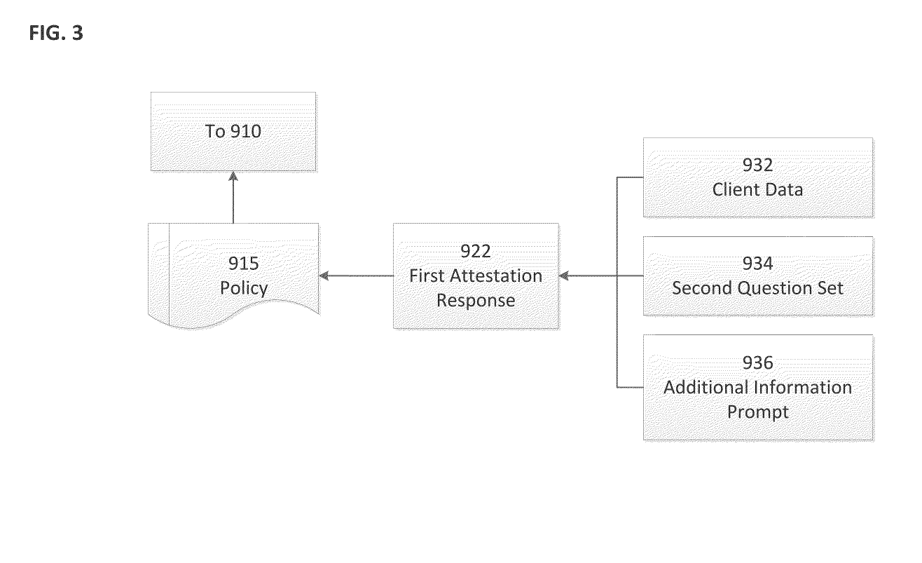

In FIG. 3, there is shown a flow diagram, which defines steps of a method according to aspects of the present disclosure. The operations depicted in FIG. 3 relate to a process by which a user may elect to purchase a policy in order to assist the user in compliance with a regulation, standard or best practice. Once such a policy has been purchased, it can be customized or configured by the system. Because pre-written “off the shelf” policies might not work for any given organization, the ability to customize a policy to suit the needs and abilities of the organization is important. The system receives client information at operation 932. The system then asks a second set of questions related to policy compliance at operation 934. The system can prompt the user for additional information at operation 936, relating to the specific policy involved. Once the user has completed the questionnaire at operation 934 and input the additional information at 936, the user then attests that its responses are accurate at operation 922. At operation 915, a custom policy is then configured based on the client data 932, the answers to the questions 934, and/or the additional information 936.

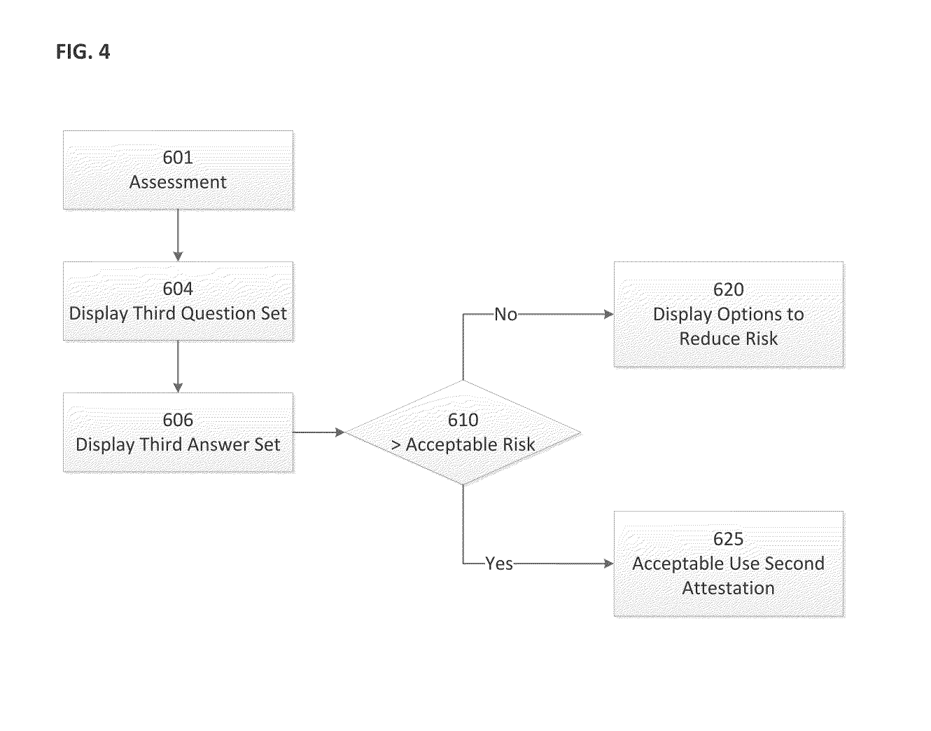

In FIG. 4, there is shown a flow diagram, which defines steps of a method according to aspects of the present disclosure. FIG. 4 represents the process of taking a particular question and answer set and deciding whether the risk associated with an answer is acceptable, or whether the user wishes to make a change to an answer in some matter. In Operation 601 the user is presented with the draft assessment as set forth in FIG. 1 at operation 500. Operation 604 represents a third set of questions, and operation 606 represents a set of answers to the third set of questions. Based on the answers in operation 606, the system displays the risk and asks the user if the risk level is acceptable at operation 610. If not, the system presents the user with options which are ways in which the organization can reduce its risk at operation 620. If so, the user is presented with an opportunity to attest to the risk level at operation 625.

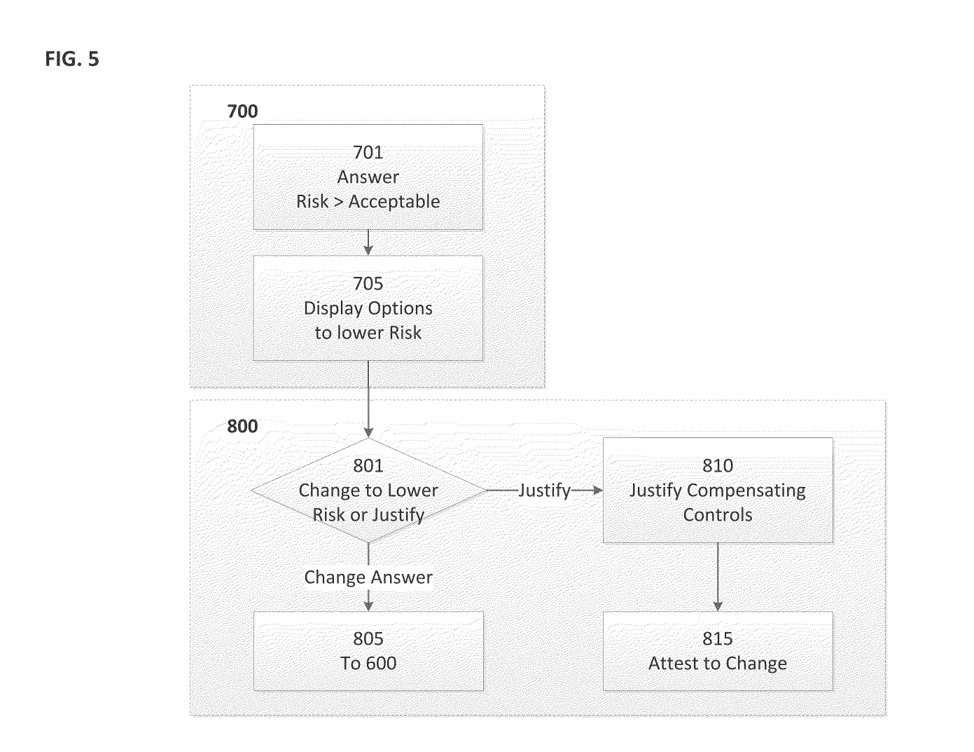

In FIG. 5, there is shown a flow diagram, which defines steps of a method according to aspects of the present disclosure. FIG. 5 represents the actions a user will take once the user decides that their answers to the questions meets an acceptable risk threshold, as shown in operations 700 and 800 in FIG. 1. In operation 701, the user has presented answers to questions that constitute a higher risk than would be acceptable. In operation 705, the user is presented with options to lower the risk level by changing one or more of the answers. In operation 800, the user can change an answer to a different answer that is considered to be of lower risk, or the user can justify its current answer as being of lower risk than the alternatives presented. In operation 801, the user is presented with the option of changing an answer or justifying its current answer and the corresponding practice. In operation 805, the user has chosen to change its answer, and its answer is then evaluated pursuant to operation 600 as shown in FIGS. 1 and 4. In operation 810, the user may justify its current practice as being of lower risk than the system believes, and/or lower risk than the alternatives, by inputting compensating controls they have in their current practice to reduce risk. Once the user has justified the risk, the user can lower the risk in view of the justification and attest to the change.

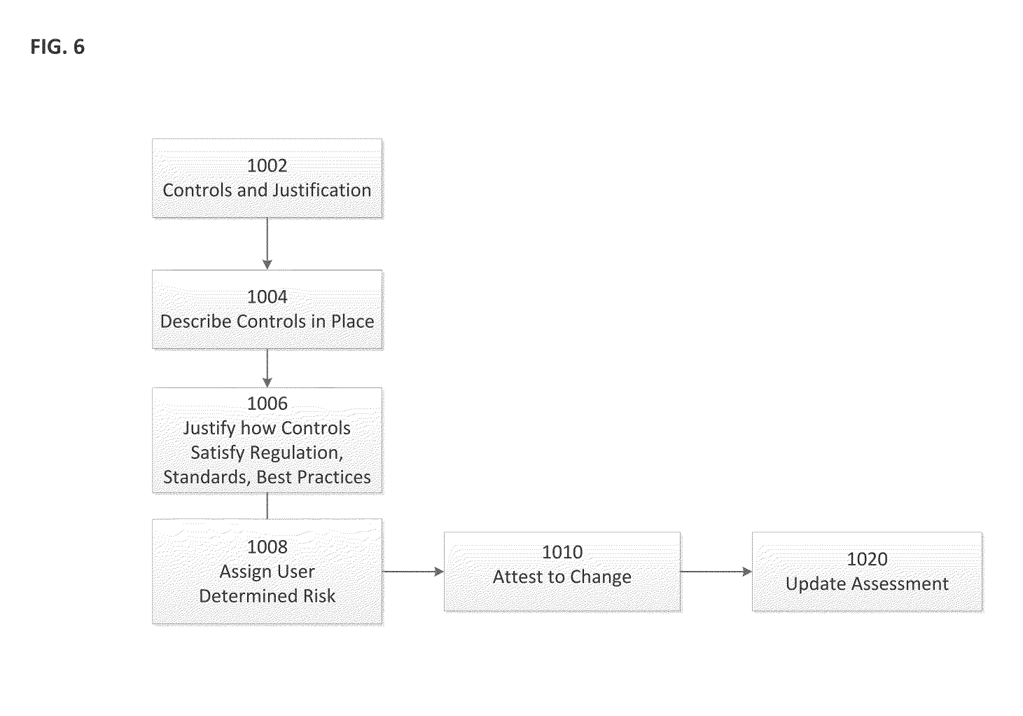

In FIG. 6, there is shown a flow diagram, which defines steps of a method according to aspects of the present disclosure. FIG. 6 represents the process of the user entering the controls and justifications in place to self assess risk. In operation 1002, the user has chosen to justify its current practice. In operation 1004, the user describes the controls it has in place to minimize risk, which controls may not be captured by the questions and answers. For example, a user may wish to note that the risk of access to paper files is mitigated by the filing cabinets being behind the desk of an individual, which limits access. In operation 1006, the user describes how the regulation, standard, or best practice is satisfied by the controls the user described in operation 1004. Operation 1008 allows the user to assign a lower level of risk in view of the controls described. In operation 1010 the user attests to its manual change to the risk level. In operation 1020 the assessment is updated to reflect the lower risk. User-entered changes are logged in the system, which notes in the assessments where user-entered justifications have been factored into a risk assessment.

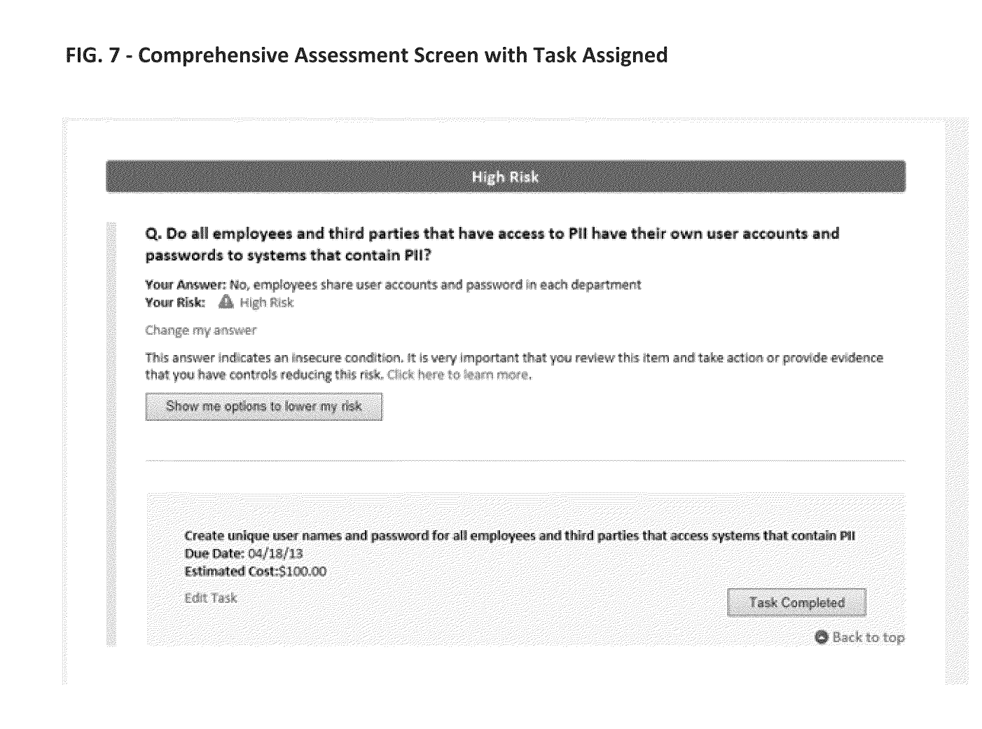

FIG. 7 depicts a transmit and/or receive interface for a question according to aspects of the present disclosure. In FIG. 7, the user is presented a question relating to a risk factor. In this example, the user is asked whether all users with access to a data set have their own user accounts and passwords. The user has answered that no, the users share user accounts and passwords. This answer is a high risk answer. At some time prior to this screen being presented in this format, the user had chosen to create a task to lower its risk, namely creating unique user names and passwords for all employees and third parties that access systems that contain the data. This screen presents the option to mark the task completed.

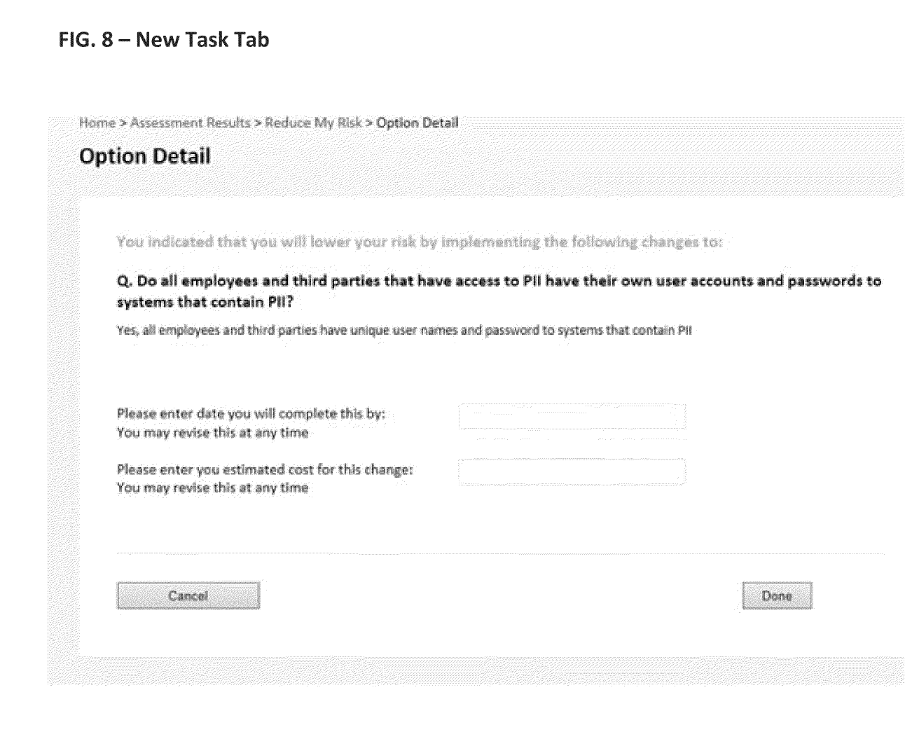

FIG. 8 depicts a transmit and/or receive interface for a prompt to enter an estimated due date of completion and cost of remediation action according to aspects of the present disclosure. FIG. 8 represents a new task tab sample. In this interface, a user has chosen to implement a change to their practices for the purposes of reducing a risk score. The user has chosen to create a task for the organization, to effectuate a change, from “no” to “yes,” to the question of whether the users each have their own user access accounts for a data set. The user is asked to enter the date upon which the user expects to have the task completed, and the estimate cost of completing the task. Completing this task creation interface can result in the task being listed in a list of tasks at various interface points in the software application, including in risk assessments. It may also export the task to other task interfaces, such as Microsoft Exchange or Outlook tasks, Google Tasks, Apple's iCloud Reminders, etc., so that the user may see and access the compliance tasks generated by the present system simultaneously with the user's other non-compliance related tasks.

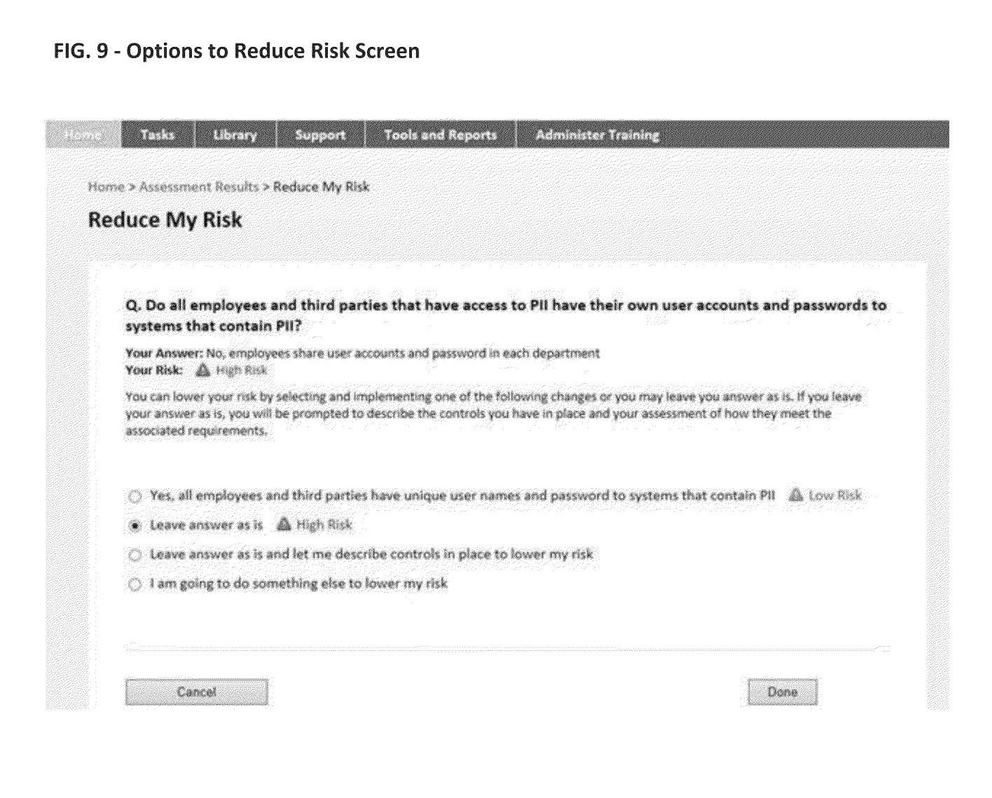

FIG. 9 depicts a transmit and/or receive interface for a request for remediation action according to aspects of the present disclosure. FIG. 9 represents an interface to present options to reduce risk. The user in this sample screen is shown that one of the user's answers presents a high level of risk. The user then choose the option to see options to change the answer to reduce the risk, which would have resulted in the user being presented with the interface of FIG. 9, which presents different options to lower risk. The options presented include a) changing the answer of the question from “no” to “yes,” in this case creating separate user accounts for the users who have access to a data set, b) leaving the answer as is, c) leaving the answer as is and justifying the risk by describing additional controls that are in place, and d) making a change that is not one of the options presented. Both the third and fourth options would trigger the process discussed with reference to FIG. 6.

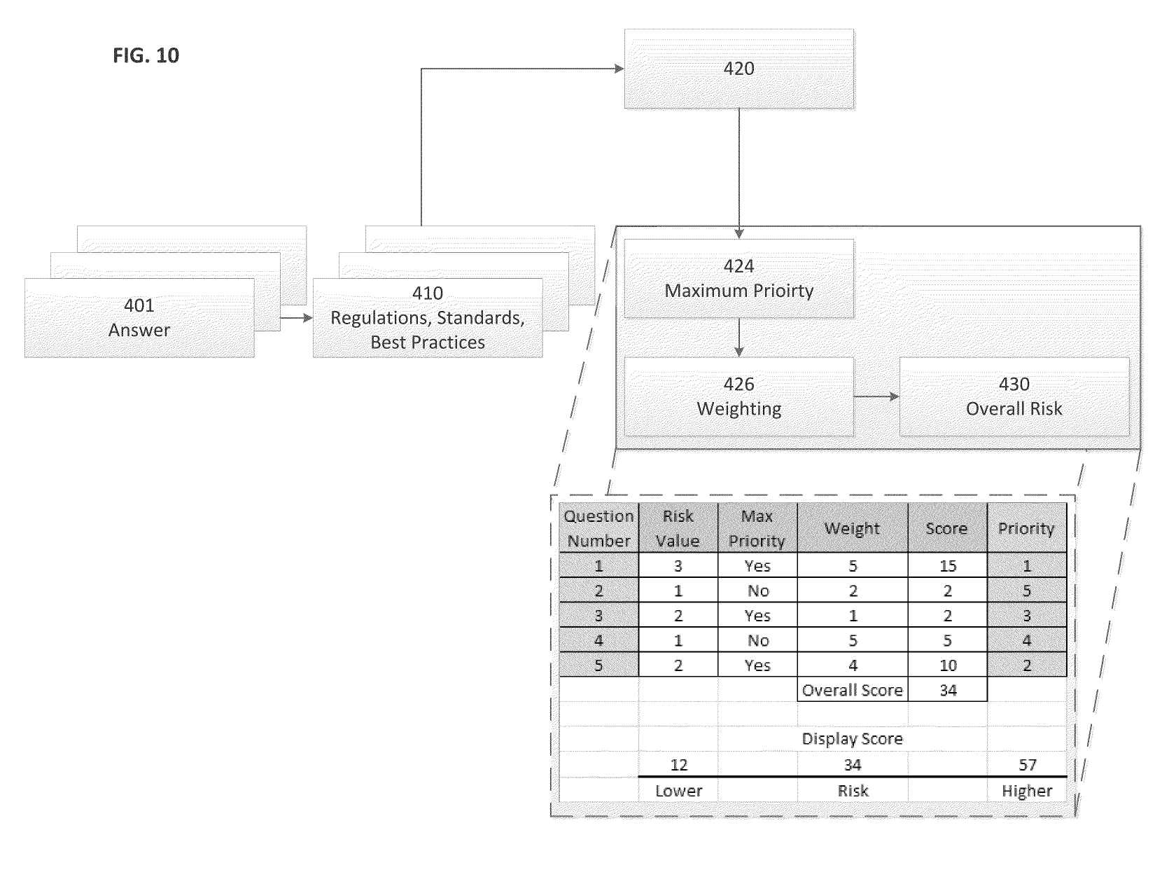

FIG. 10 represents the weighting and maximum priority process in accordance with one aspect of the present disclosure. The system contains a set of answers 401, each of which is linked to one or more regulations, standards or best practices 410. Each answer has an associated priority and an associated weight, which are taken into account when determining a risk factor. Accordingly, the system can measure risk by merely counting the number of low risk answers, medium risk answers, and high risk answers and taking an average. However, the system preferably attaches higher priorities to different questions and their answers than to others, such that a high priority question with a high risk answer can result in a finding of high risk, despite a multitude of low risk answers to other lower priority questions relating to the same regulation, standard, or best practice. In addition to priority, each question is given a weight of its importance to compliance with the regulation, standard or best practice. Weighting can assign more importance to the riskiness of, for example, a medium risk answer to a highly weighted question. The weight and priority for each question are factored into the calculation of the displayed risk score.

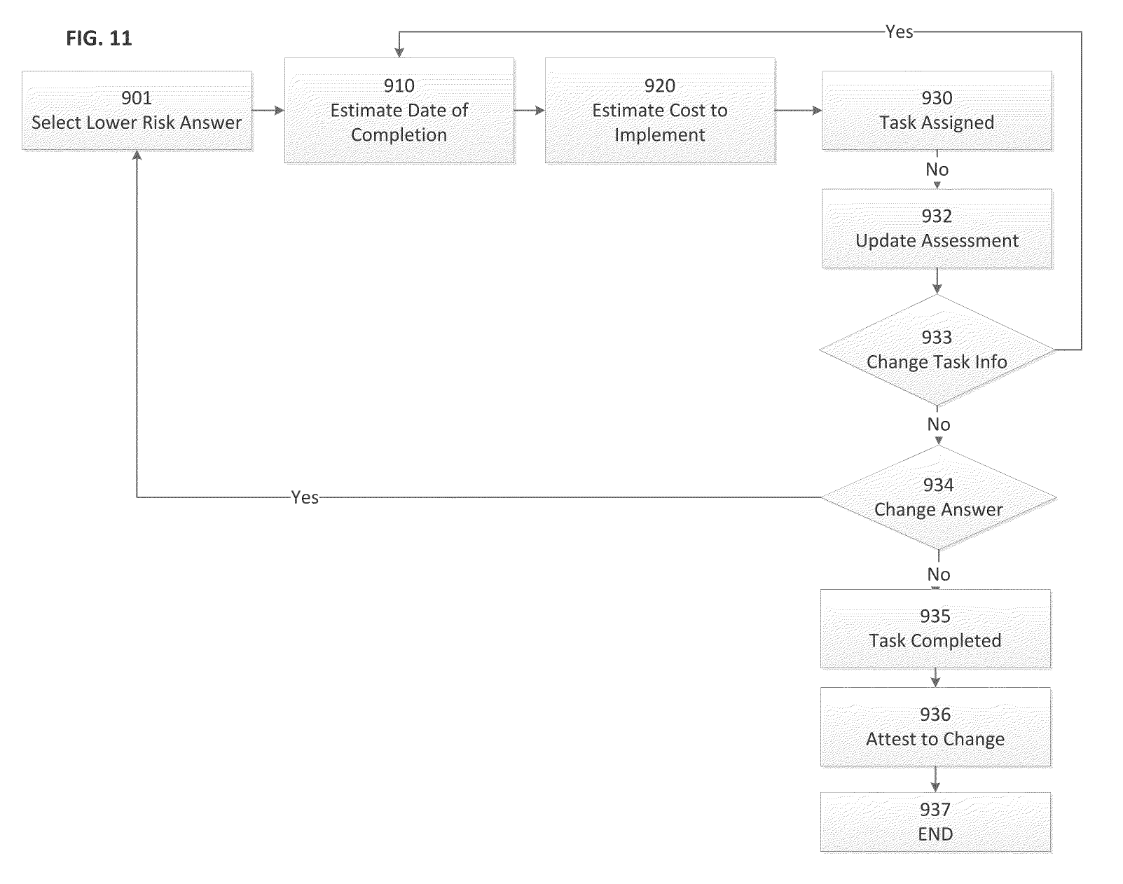

FIG. 11 represents the process by which a user has decided to select and implement a change to an answer, in order to reduce risk. In operation 901 a user selects a lower risk answer to implement in order to reduce risk. In operation 910 the user is asked for an estimated date of completion for the task, and in operation 920 the user is asked to input the estimated cost. In operation 930 the task is assigned, and the assessment is then updated and displayed. User can later change dates or costs of completion 933 or the task itself 934, which would repeat the process beginning at operation 901. The user can mark task completed once it is completed, at operation 935, can attest to its completion at 936. The process ends at operation 937.

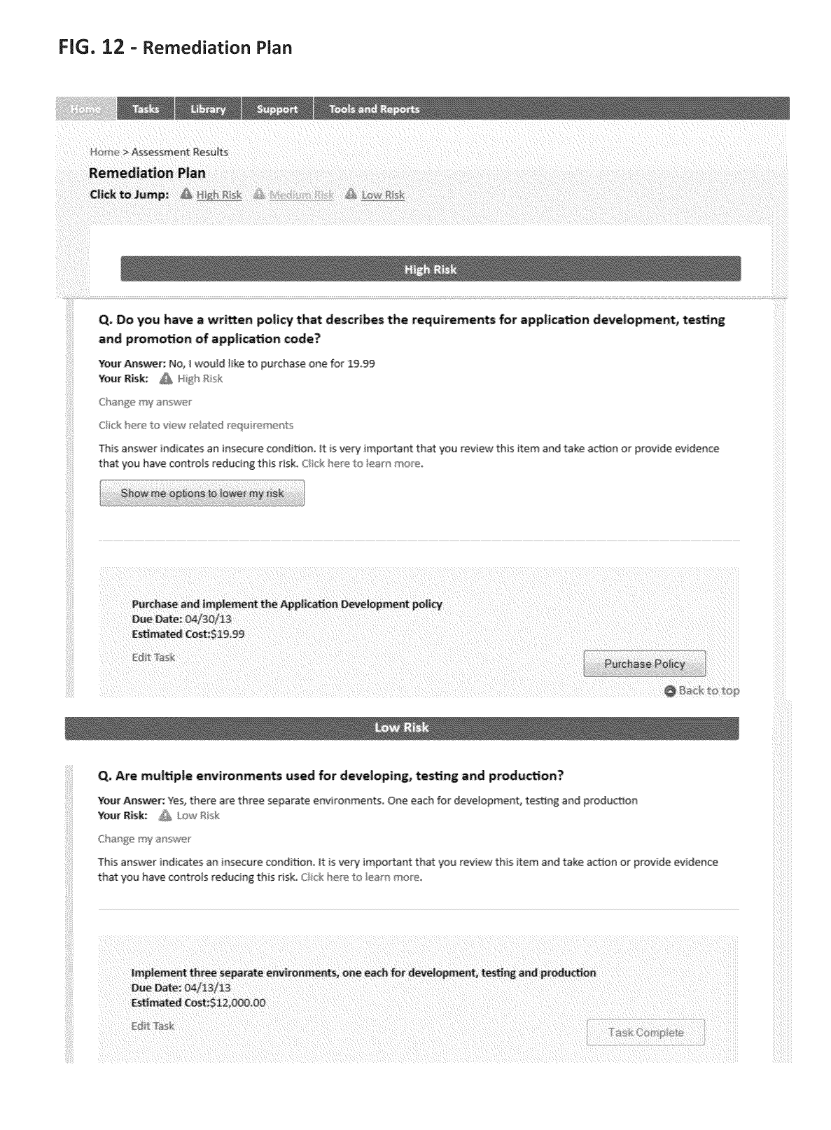

FIG. 12 depicts a transmit and/or receive interface for an assessment according to aspects of the present disclosure. The assessment may include, for example, information relating to a remediation action including, for example, an estimated date of completion, an estimated cost of completion and other information related to the remediation action. A remediation plan is made up of a set of tasks that the user has been assigned in order to make changes to reduce risk. In this particular example, an option to purchase a written policy, for the purposes of implementing the policy to reduce risk, is presented to the user.

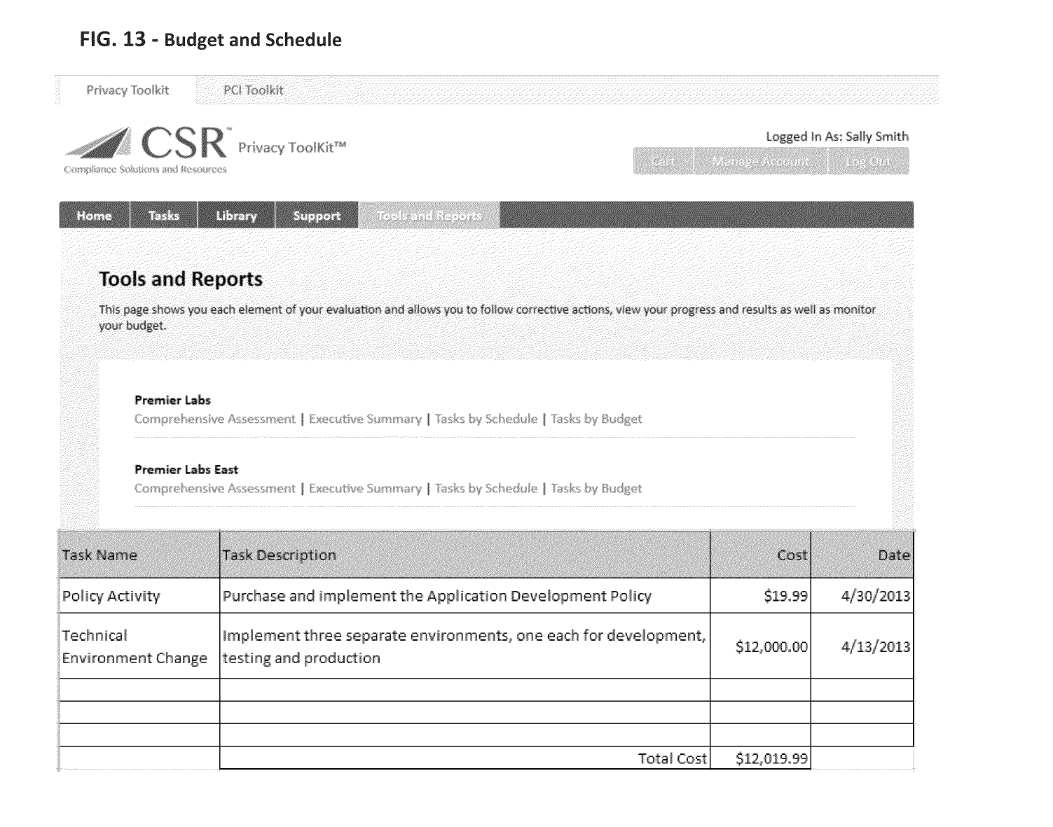

FIG. 13 represents a budgeting and scheduling interface in accordance with aspects of the present disclosure. The interface shows links to different assessments for each location, and a list of the tasks that have been assigned to the user in response to their answers to questions and the choices they have made in response to the system's evaluation of the risk associated with those answers.

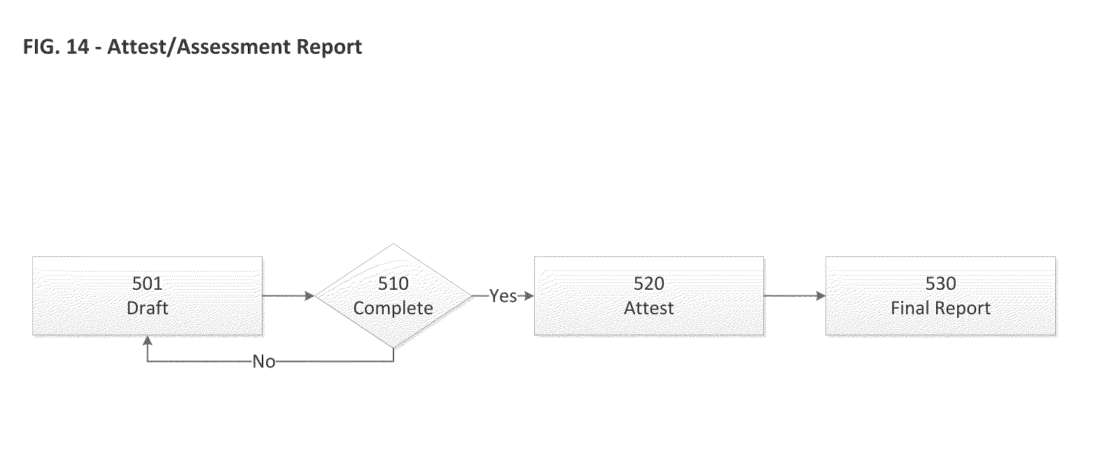

FIG. 14 represents the process of attestation to a risk assessment. In operation 501, the user is presented with a draft assessment, which may including a list of questions, answers, and associated risk that a user had given in response to the system. Operation 510 represents the user's review of the report and the user's answer as to whether the report is complete. Once the report is complete in the eyes of the user, the user can attest to the risk level appearing in the assessment report in operation 520, in which case a final report is generated in operation 530.

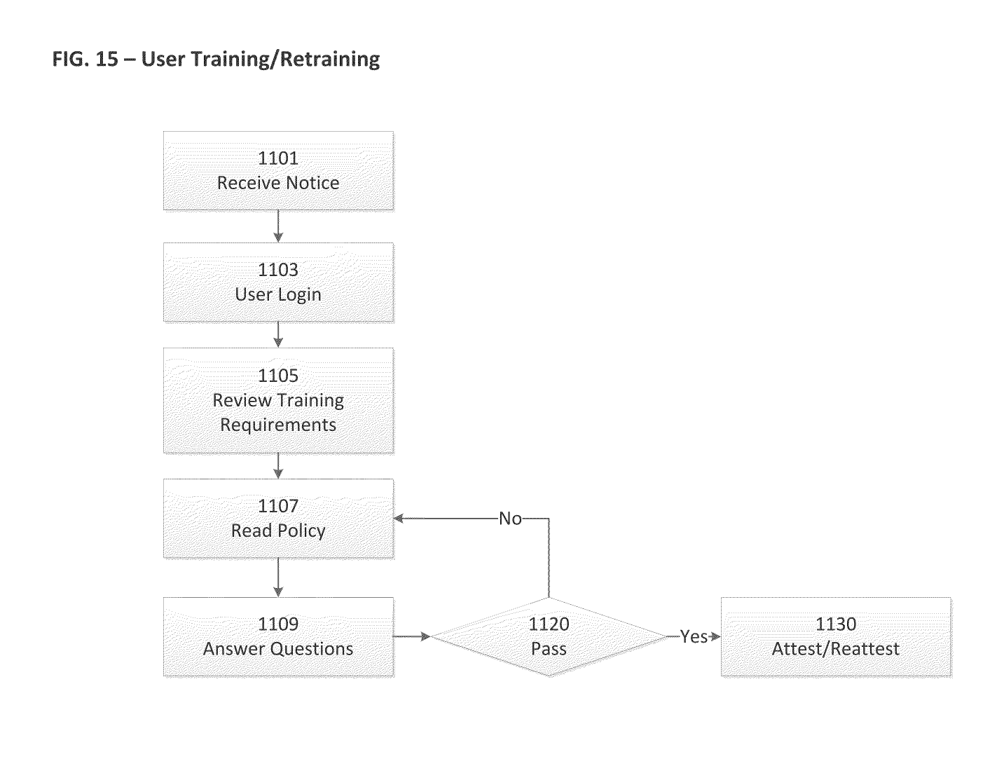

FIG. 15 represents a user training process. In operation 1101, a user will receive notice that he or she is required to receive training. Policies that are acquired by organizations in accordance with the present disclosure may from time to time require users within the organization to receive training on compliance with the policy. Once the training begins, the user logs in, in operation 1103. The user then reviews the training requirements, including what they are required to read or examine, how often, etc., in operation 1105. The user then is given the policy to read in operation 1107, and then is given questions to which responses are required in operation 1109, to prove that the user has read and understood the policy. If the user gives a sufficient number of correct answers in operation 1120, the user may attest that he or she has received training in the policy in operation 1130.

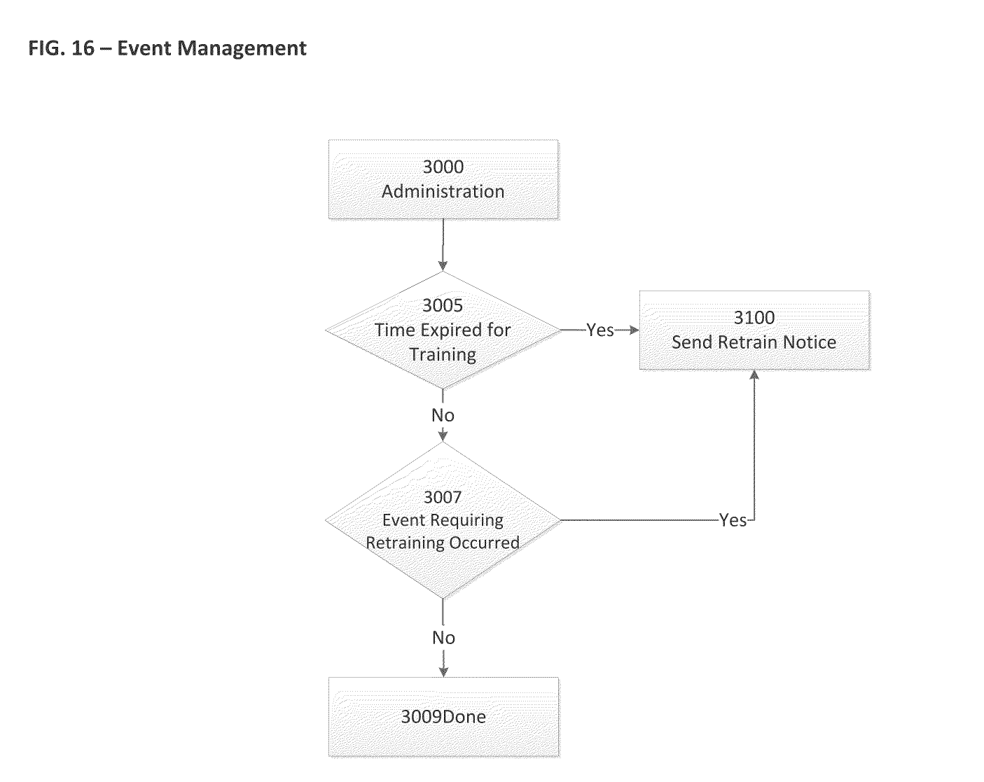

FIG. 16. Represents the event management process of a training module in accordance with an aspect of the present disclosure. The system may determine that a user who has already been trained requires training again. This may be because a time limit has expired 3005, requiring a training refresh, or because an event occurred which requires retraining 3007. Such events could, by way of example, be a discovery of non-compliance with the policy by that user, such as in an audit. In either event, the user is sent a retraining requirements notice 3100. If no training is required, this process ends 3009.

FIG. 17 shows an illustrative computer system 2000 suitable for implementing methods and systems according to an aspect of the present disclosure. The computer system may comprise, for example, a computer running any of a number of operating systems. The above-described methods of the present disclosure may be implemented on the computer system 2000 as stored program control instructions.

Computer system 2000 includes processor 2100, memory 2200, storage device 2300, and input/output structure 2400 (e.g., transmitting and/or receiving structure). One or more input/output devices may include a display 2450. One or more busses 250 typically interconnect the components, 2100, 2200, 2300, and 2400. Processor 2100 may be a single or multi core.

Processor 2100 executes instructions in which aspects of the present disclosure may comprise steps described in one or more of the Figures. Such instructions may be stored in memory 2200 or storage device 2300. Data and/or information may be received and output using one or more input/output devices.

Memory 2200 may store data and may be a computer-readable medium, such as volatile or non-volatile memory, or any transitory or non-transitory storage medium. Storage device 2300 may provide storage for system 2000 including for example, the previously described methods. In various aspects, storage device 2300 may be a flash memory device, a disk drive, an optical disk device, or a tape device employing magnetic, optical, or other recording technologies.

Input/output structures 2400 may provide input/output operations for system 2000. Input/output devices utilizing these structures may include, for example, keyboards, displays 2450, pointing devices, and microphones—among others. As shown and may be readily appreciated by those skilled in the art, computer system 200 for use with the present disclosure may be implemented in a desktop computer package 2600, a laptop computer 2700, a hand-held computer, for example a tablet computer, personal digital assistant, mobile device, or smartphone 2800, or one or more server computers that may advantageously comprise a “cloud” computer 2900.

At this point, while we have discussed and described the disclosure using some specific examples, those skilled in the art will recognize that our teachings are not so limited. Accordingly, the disclosure should be only limited by the scope of the claims attached hereto.

1. A computer for technical standards guidance information for a business, the method comprising:
memory having at least one region for storing computer executable program code; and
processor for executing the program code stored in the memory, wherein the program code comprises:
code for transmitting for display a first question set to a user, the first question set including a simplified translation of technical questions from master requirements relating to a Standard, Regulation or Best Practice regarding how the business processes medical, privacy or regulated information, and receiving a first answer set from the user in response to the first question set;
code for transmitting for display to the user a first attestation that the business conforms to a first technical standard relating to the first answer set and continuing processing upon receiving a first attestation response from the user;
code for transmitting a second question set regarding the handling by the business of personally identifiable information, protected health information or other confidential information, and receiving a second answer set from the user in response to the second question set;
code for identifying one or more answers from the second answer set that do not satisfy one or more corresponding master requirements and identifying the corresponding unsatisfied master requirements accordingly;
code for transmitting for display to the user a third question set based on the unsatisfied master requirements regarding policies or procedures of the business, wherein one or more questions in the third question set may correspond to one unsatisfied master requirement;
code for receiving a third answer set from the user including yes, no, not applicable, and multiple choice answers in response to the second question set and automatically building at least one of a policy or a procedure based on the second answer set and transmitting the at least one policy or procedure to the user;
code for receiving user input to change an answer in the first or second or third answer set from an unsatisfactory answer to a satisfactory answer under the master requirements or create compensating controls for that answer;
code for assigning a risk value to each answer in the second answer set;
code assigning a priority value to each question in the second question set;
code for calculating and transmitting for display to the user an overall risk score based on risk values and priority values;
code for generating and transmitting for display a remediation task to the user when the risk value for an answer within the first and second and third answer sets is above a predetermined threshold risk value for that answer;
code for offering the user the opportunity to change, modify or specify compensating controls to include in a remediation plan;
code for generating and transmitting for display to the user the remediation plan including a hierarchical list of remediation tasks prioritized by the risk value for the individual tasks and further including the at least one policy or procedure previously transmitted to the user;
code for generating and transmitting for display to the user a budget and schedule for each remediation task;
code for transmitting for display a second attestation to the user regarding completion of the remediation tasks where the user certifies that each remediation task is complete and then updates the corresponding previously answered questions from the first or second question set to reflect the user certification and receiving and time-stamping a second attestation response from the user for each task and continuing processing upon receiving a second attestation response from the user;
code for transmitting for display to the user a third attestation to the user and receiving and time-stamping a third attestation regarding the identity of the user and continuing processing upon receiving a third attestation response from the user;
code for generating and transmitting for display to the user a confirmed assessment report based on completion of all remediation tasks; and
code for transmitting for display to the user a fourth attestation that the assessment report is accurate and receiving and time-stamping a fourth attestation and continuing processing upon receiving a fourth attestation response from the user.

2. The computer for technical standards guidance information for a business of claim 1, wherein the program code further comprises:
code for generating and transmitting for display to the user training and tests;
code for receiving from the user test answers;
code for grading and recording test answers and transmitting to the user test results;
code for monitoring training expiration dates and notifying the user of a need for training upon expiration;
code for transmitting for display to the user a fifth attestation that training was completed by the person attesting and that the results are the true work of the attester and continuing processing upon receiving a fifth attestation response from the user;
code for notifying the user and re-training and re-testing all or some employees of the user upon an occurrence of a predetermined security or procedural event; and
code for transmitting for display to the user a sixth attestation that re-training and re-testing was completed by the person attesting and continuing processing upon receiving a sixth attestation response from the user.

3. The computer for technical standards guidance information for a business of claim 1, further comprising:
code for receiving a response to the request to select the remediation task; and
code for generating and transmitting, if the response is associated with a lower risk score, a prompt to enter an estimated date of completion and cost of the remediation task.

4. The computer for technical standards guidance information for a business of claim 1, further comprising:
code for receiving a response to the request to select the remediation task; and
code for generating and transmitting, if a remediation task associated with a lower risk score is not selected, a prompt to enter justification information.

5. The computer for technical standards guidance information for a business of claim 4, wherein the justification information includes current or planned compensating controls in place to mitigate risk, an assessment of how the compensating controls satisfy statutory, sectoral or standards requirements, and user determined risk score.

6. The computer for technical standards guidance information for a business of claim 1, further comprising:
code for receiving said first question set, said second question set, or said third question set from a server to the computer;
code for sending said first answer set, said second answer set, or said third answer set to the server;
code for receiving the assessment from the server to the user; and
code for receiving the request for remediation action from the server.

7. The computer for technical standards guidance information for a business of claim 1, wherein the business is selected from the group consisting of a health care provider, health care payer, health care clearinghouse, and a health plan.

8. The computer for technical standards guidance information for a business of claim 1, wherein the regulation, standard, or best practice include Health Insurance Portability and Accountability Act (HIPAA) requirements.

9. The computer for technical standards guidance information for a business of claim 1, wherein the regulation, standard or best practice include Health Information Technology for Economic and Clinical Health (HITECH) requirements.
